(19) United States
(12) Patent Application Publication
(10) Pub. No.: US 2019/0219139 A1
(43) Pub. Date: Jul. 18, 2019

(54) FIXED BLOCK SHAFT FOR INTEGRATED DRIVE GENERATOR

(71) Applicant: HAMILTON SUNDSTRAND CORPORATION, Charlotte, NC (US)

(72) Inventors: Derek R. Hochstetler, Rockford, IL (US); Ted A. Martin, Byron, IL (US); Duane C. Johnson, Beloit, WI (US); Glenn C. Lemmers, JR., Loves Park, IL (US)

(21) Appl. No.: 15/871,449

(22) Filed: Jan. 15, 2018

(51) Int. Cl. F16H 39/14; F16C 3/02; F16H 57/00; F16H 47/04

(52) U.S. Cl. CPC F16H 39/14; F16H 47/04; F16H 57/0025; F16C 3/02

(57) ABSTRACT

A fixed block shaft has a body extending from a first end to a second end. A disc extends radially outwardly of a shaft portion. The shaft portion extends to the second end. The disc extends radially outwardly from the shaft adjacent the first end with a boss extending to the first end from the disc. The boss defines an inner peripheral surface and the inner peripheral surface has a bearing race. The bearing race extends from the first end to a bearing race end. An inner diameter of the bearing race defines a first distance. An inner diameter of the bearing race is defined as a first distance and the bearing race extends along a central axis for a second distance. A ratio of the first distance to the second distance is between 4.30 and 4.50. An integrated drive generator and a method are also disclosed.

### BACKGROUND

This application relates to a fixed block shaft for use in a hydraulic unit of an integrated drive generator.

Integrated drive generators are known and often utilized in aircraft. As known, a gas turbine engine on the aircraft provides a drive input into a generator input shaft. The generator typically includes a disconnect shaft that can transmit the input into a gear differential. The gear differential selectively drives a main generator to provide electric power for various uses on the aircraft.

It is desirable that the generated power be of a desired constant frequency. However, the speed from the input shaft will vary during operation of the gas turbine engine. This would result in variable frequency.

Integrated drive generators are provided with speed trimming hydraulic units. Gears associated with the differential and, in particular, a ring gear portion, provide rotation from the differential back into the trimming unit. A carrier also rotates another portion of the trimming unit. The trimming unit is operable to result in the output speed of the differential being effectively constant, such that electric power of a desirable frequency is generated.

The generator is mounted between two housing portions and a seal plate is mounted between the two housing portions.

In addition, various accessory systems, such as various pumps, are driven by the ring gear of the differential through an accessory drive gear.

A fixed block shaft, which is part of the speed trimming hydraulic unit, faces design challenges.

### SUMMARY

A fixed block shaft for use in an integrated drive generator has a body extending from a first end to a second end. A disc extends radially outwardly of a shaft portion. The shaft portion extends to the second end. The disc extends radially outwardly from the shaft adjacent the first end with a boss extending to the first end from the disc. The boss defines an inner peripheral surface and the inner peripheral surface has a bearing race. The bearing race extends from the first end to a bearing race end. An inner diameter of the bearing race defines a first distance. An inner diameter of the bearing race is defined as a first distance and the bearing race extends along a central axis for a second distance. A ratio of the first distance to the second distance is between 4.30 and 4.50.

In addition, an integrated drive generator and a method of replacing a fixed block shaft from an integrated drive generator are disclosed.

These and other features may be best understood from the following drawings and specification.

### BRIEF DESCRIPTION OF THE DRAWINGS

FIG. 1 schematically shows an integrated drive generator.

FIG. 2 schematically shows hydraulic units in the integrated drive generator.

FIG. 3 shows the components of a hydraulic unit.

FIG. 4A shows a fixed block shaft.

FIG. 4B is a cross-section through the shaft.

FIG. 4C shows a gear tooth profile.

FIG. 4D shows a second spline tooth profile.

### DETAILED DESCRIPTION

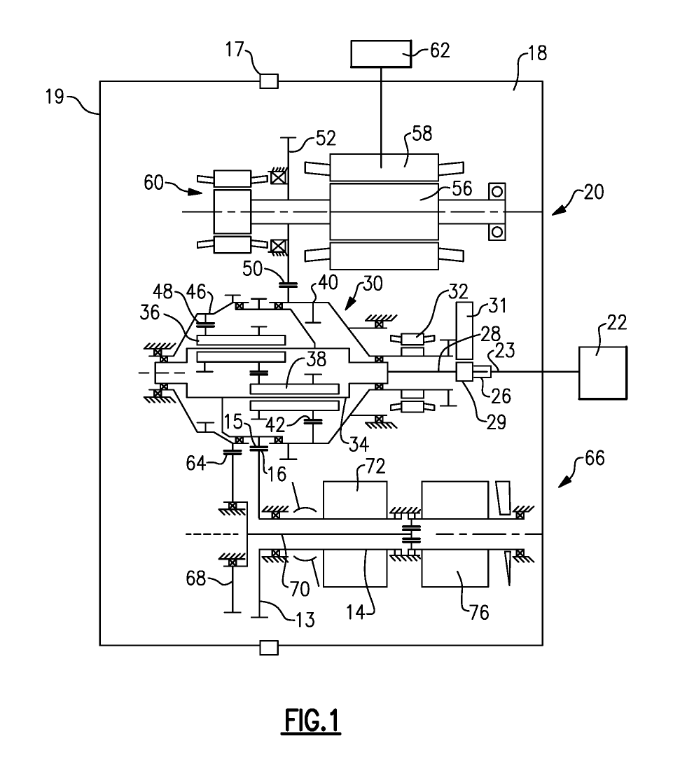

FIG. 1 shows an integrated drive generator 20. As shown, housing portions 18 and 19 surround the integrated drive generator and a seal plate 17 sits between the housing portions 18 and 19.

A gas turbine engine 22 may drive an input shaft 23 which selectively drives a disconnect assembly 26. The disconnect assembly 26, in turn, drives a carrier shaft 28, which drives a carrier in a gear differential 30.

As the carrier shaft 28 rotates, planet gears 36 and 38 are caused to rotate. Gears 38 have a gear interface 42 with a first ring gear portion 40. Gears 36 have a gear interface 48 with a second ring gear portion 46.

Ring gear portion 40 has a gear interface 50 with a main generator drive gear 52. When drive gear 52 is driven to rotate, it rotates a rotor 56 associated with a stator 58 of the main generator as well as an exciter rotor 60. Electric power is generated for a use 62, as known.

It is desirable that the frequency of the generated electric power be at a desired frequency. This requires the input speed to gear 52 to be relatively constant and at the desired speed. As such, the speed of the input shaft 23 is added to the speed of the speed trimmer 66 to result in a constant input speed to gear 52.

A gear 15 that is part of the carrier has a gear interface 16 with a gear 13 driving a shaft 14 also within the speed trimmer.

As known, the speed trimmer 66 includes a variable unit 72 and a fixed unit 76. The units 72 and 76 may each be provided with a plurality of pistons and a swash plate arrangement. If the input speed of the gear 13 is too high, the speed of the gear 52 will also be too high, and hence, the speed trimmer 66 acts to lower the speed of the trim gear 46 which will drop the speed of gear 52. On the other hand, if the input speed is too low, the speed trimmer will increase the trim gear speed and the speed seen by gear 52 will increase.

In essence, the variable unit 72 receives an input through gear 13 that is proportional to the speed of the input shaft 23. The variable unit 72 also receives a control input from a control monitoring the speed of the generator rotor 56. The position of the swash plate in the variable unit 72 is changed to in turn change the speed and direction of the fixed unit 76. The fixed unit 76 can change the speed, and direction of rotation of the shaft 70, and this then provides control back through the trim ring gear 46 to change the speed reaching the generator. In this manner, the speed trimmer 66 results in the frequency generated by the generator being closer to constant, and at the desired frequency.

A permanent magnet generator 32 rotates with the ring gear 40.

An accessory drive shaft 29 rotates with the ring gear 40 and drives a plurality of accessory gears 31.

The operation of the integrated drive generator 20 is generally as known in the art. A worker of ordinary skill would recognize that the desired frequency and speed at use 62 would dictate a number of design functions.

FIG. 2 shows that there are a pair of hydraulic or speed trimming units 66 associated with a single ring gear 46 and a single carrier 15.

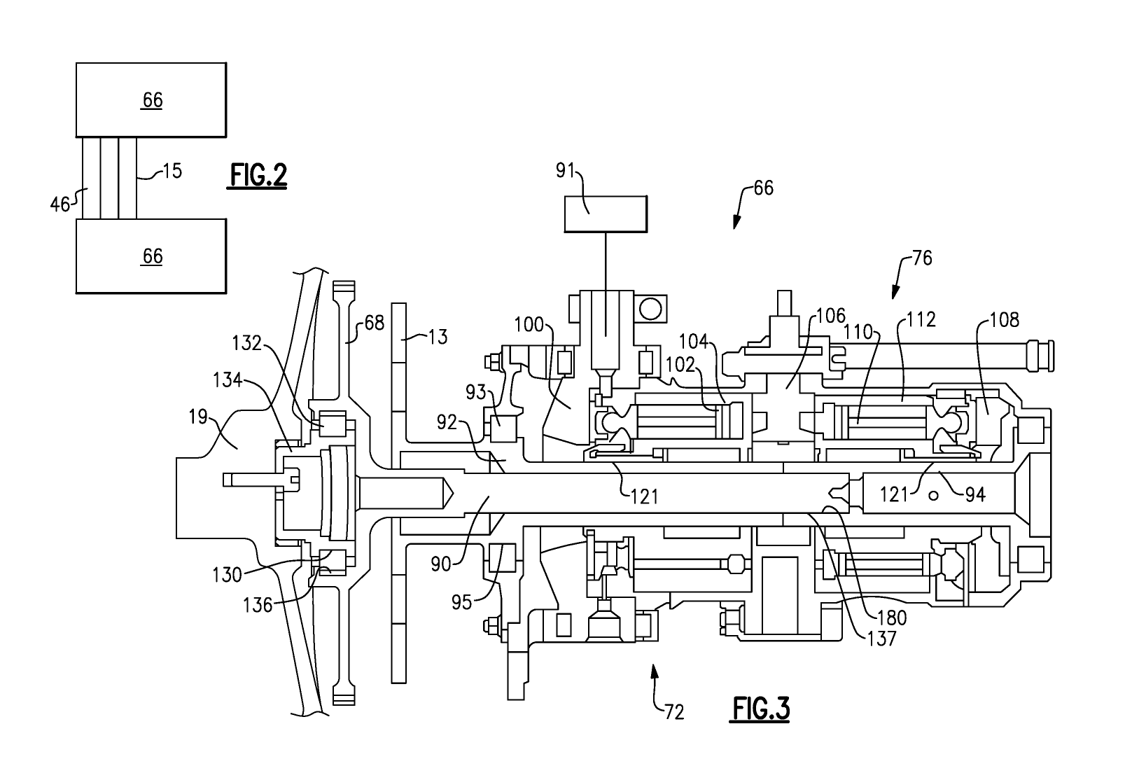

FIG. 3 shows details of the hydraulic unit 66. A speed into the gear 13 will be proportional to the speed from the input shaft 23. The gear 13 rotates with a shaft 92. The shaft 92 is supported on bearing 93. The shaft, through splined teeth 121, drives a cylinder block 104 to rotate.

The shaft 90 is called a fixed block shaft, although it rotates. The shaft 90 is supported on a bearing 132 received on a bearing race 130 on the fixed shaft 90. In addition, an inner race 134 for the bearing 132 is mounted on a housing 19. The inner race 134 includes a race surface 136.

A control 91 changes the position of a swash plate 100 based upon the input speed seen at the generator. As the cylinder block 104 rotates, pistons 102 within the cylinder block cam off a surface of the swash plate 100. As the position of the swash plate 100 is changed by control 91, the amount of hydraulic fluid driven by the pistons 102, through a port plate 106, and against piston 110 in a cylinder block 112 changes. As the pistons 110 move, they cam off a surface of fixed swash plate 108. This results in a control of a speed and direction of rotation of cylinder block 112. Cylinder block 112 has a spline connection at 121 to a shaft 94. Thus, the hydraulic unit 66 results in a desired speed and direction of rotation of the shaft 94, ultimately based upon the input speed seen at the generator. The shaft 94 drives the shaft 90 through spline teeth at 137 to in turn drive the gear 68. The gear 68 interacts with the trim ring gear 46 such that the ultimate speed leaving the differential 30 to the gear 52 is controlled to achieve a constant desired speed at the generator.

The cylinder blocks 104 and 112 are effectively identical. In addition, there are similar cylinder blocks 104/112 in both of the hydraulic units 66.

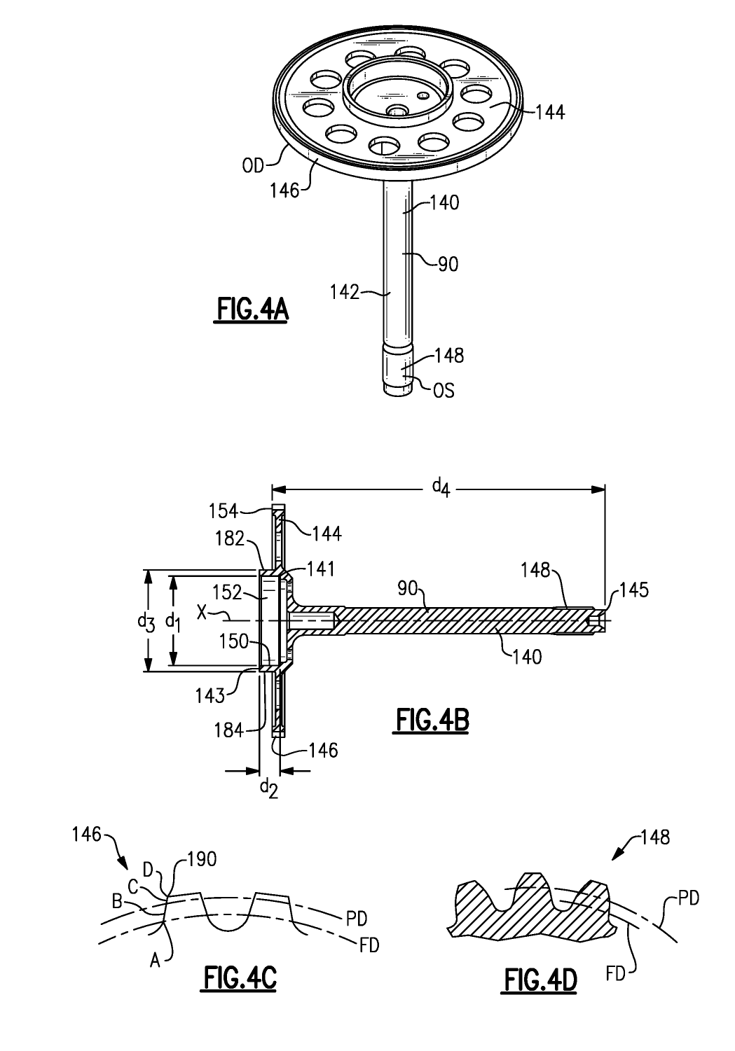

FIG. 4A shows details of the fixed block shaft 90. A body 140 of the shaft 90 includes a shaft portion 142 and extends to a disc 144, extending radially outwardly of the shaft 142. In addition, gear teeth 146 are formed at an outer diameter OD of the disc 144 and provide the gear interface shown at 64 with the ring gear 46. Splines 148 are formed at an outer shaft OS and provide the connection at 137 to spline teeth on the shaft 94.

As can be appreciated, the shaft 90 is supported within a bore 180 of the shaft 94 and the shaft 94 will have spline teeth at its inner periphery for providing its half of the engagement at 137.

FIG. 4B is a cross-section through the shaft 90. The body 140 is shown as extending from a first end 143 to a second end 145. A recess 152 is shown extending to end 143 and includes a bearing race surface 150. The bearing race 150 extends from end 143 to a bearing race end 141. A diameter across the bearing race 150 is defined as d₁. In embodiments, d₁ was 1.968 inches (4.999 centimeters). A boss 182 extends forwardly of the disc 144 to the end 143 and defines the recess 152.

A distance d₂ is defined from the length of the bearing race along a central axis X, between end 143 and bearing race end 141. In embodiments, d₂ was 0.448 inch (1.13 centimeters).

An outer surface 184 of the boss 182 defines an outer diameter d₃. In an embodiment, d₃ was 2.221 inches (5.641 centimeters).

A distance d₄ is defined between a forward end 154 of the disc 144 and the end 145. In an embodiment d₄ was 7.018 inches (17.823 centimeters). It should be understood that this and all dimensions in the application carry a tolerance of +/−0.010 inch (0.025 centimeters).

In embodiments, a ratio of d₁ to d₃ was between 0.80 and 0.95. A ratio of d₁ to d₂ was between 4.30 and 4.50_. A ratio of d₃ to d₄ was between 0.25 and 0.40.

FIG. 4C shows a gear tooth profile for the teeth 146. As known, gear teeth can be defined by the roll angles at points A, B, C, and D. It is known in the art how to define the locations and defining the location of these points forms no portion of this disclosure. However, the roll angles themselves are unique. In an embodiment, angle A is at a maximum form diameter FD. Angle B is 20% away from point A and toward an outer tip of the gear teeth and outer tip 190 of the gear teeth. The roll angle at C is spaced 80% percent from point A and the roll angle at D is at the point 190.

In an embodiment, the pitch diameter was 5.00 inches (12.700 centimeters). The maximum form diameter was 4.89 inches (12.421 centimeters). The roll angle at A was 16.7 degrees and in embodiments between 16.0 and 17.5 degrees. The roll angle at B was 18.2 degrees and in embodiments between 17.4 and 18.9 degrees. The roll angle at C was 22.4 degrees and in embodiments between 21.7 and 23.2 degrees. The roll angle at D was 23.8 degrees and in embodiments between 23.1 and 24.6 degrees.

FIG. 4D shows the splines 148. Here, the pitch diameter was 0.550 inch (1.397 centimeters). The maximum form diameter was 0.525 inch (1.334 centimeters.) In embodiments, there are 22 spline teeth 148 and 100 of the gear teeth 146.

A method of replacing a fixed block shaft includes the steps of removing an existing fixed block shaft from an integrated drive generator having an input shaft connected to a differential, which is connected to a generator, and also to a hydraulic unit. The hydraulic unit includes a variable swash plate and a fixed swash plate, each being associated with a set of pistons. A fixed shaft is associated with the fixed shaft plate, and driven to rotate by a cylinder block associated with the fixed swash plate. The fixed shaft includes a spline connection to drive the existing fixed block shaft, which has gear teeth engaged to a ring gear in the differential. The existing fixed block shaft is replaced with a replacement fixed block shaft having a body extending from a first end to a second end and a disc extending radially outwardly of a shaft portion. The shaft portion extends to the second end and the disc extends radially outwardly from the shaft adjacent the first end with a boss extending to the first end from the disc. The boss defines an inner peripheral surface, which is a bearing race. The bearing race extends from the first end to a bearing race end. An inner diameter of the bearing race defines a first distance. An inner diameter of the bearing race is defined as a first distance and the bearing race extending along a central axis for a second distance. A ratio of the first distance to the second distance is between 4.30 and 4.50.

Although an embodiment of this invention has been disclosed, a worker of ordinary skill in this art would recognize that certain modifications would come within the scope of this disclosure. For that reason, the following claims should be studied to determine the true scope and content of this disclosure.

1. A fixed block shaft for use in an integrated drive generator comprising:
a body extending from a first end to a second end, and a disc extending radially outwardly of a shaft portion, said shaft portion extending to said second end and said disc extending radially outwardly from said shaft adjacent said first end with a boss extending to said first end from said disc, said boss defining an inner peripheral surface, and said inner peripheral surface being a bearing race, and said bearing race extending from said first end to a bearing race end, and an inner diameter of said bearing race defining a first distance, an inner diameter of said bearing race being defined as a first distance and said bearing race extending along a central axis for a second distance, and a ratio of said first distance to said second distance being between 4.30 and 4.50.

2. The fixed block shaft as set forth in claim 1, wherein an outer diameter of said boss is defined as a third distance, and a ratio of said first distance to said third distance being between 0.80 and 0.95.

3. The fixed block shaft as set forth in claim 2, wherein a fourth distance defined between an end of said disc facing said first end and said second end and a ratio of said second distance to said fourth distance being between 0.050 and 0.075.

4. The fixed block shaft as set forth in claim 3, wherein gear teeth are formed at an outer periphery of said disc, and spline teeth are formed at an outer surface of said fixed shaft.

5. The fixed block shaft as set forth in claim 4, wherein there are one hundred gear teeth and twenty-two spline teeth.

6. The fixed block shaft as set forth in claim 1, wherein gear teeth are formed at an outer periphery of said disc, and spline teeth are formed at an outer surface of said fixed shaft.

7. The fixed block shaft as set forth in claim 6, wherein there are one hundred gear teeth and twenty-two spline teeth.

8. An integrated drive generator comprising:
an input shaft connected to a differential, said differential connected to a generator, and said differential also being connected to a hydraulic unit, said hydraulic unit including a variable swash plate and a fixed swash plate, and each of said swash plates being associated with a set of pistons, and a fixed shaft associated with said fixed shaft plate, and driven to rotate by a cylinder block associated with said fixed swash plate, and said fixed shaft including a spline connection to drive a fixed block shaft, said fixed block shaft having gear teeth engaged to a ring gear in said differential; and
said fixed block shaft having a body extending from a first end to a second end and a disc extending radially outwardly of a shaft portion, said shaft portion extending to said second end and said disc extending radially outwardly from said shaft adjacent said first end with a boss extending to said first end from said disc, said boss defining an inner peripheral surface, and said inner peripheral surface being a bearing race, and said bearing race extending from said first end to a bearing race end, and an inner diameter of said bearing race defining a first distance an inner diameter of said bearing race being defined as a first distance and said bearing race extending along a central axis for a second distance, and a ratio of said first distance to said second distance being between 4.30 and 4.50.

9. The integrated drive generator as set forth in claim 8, wherein an outer diameter of said boss is defined as a third distance, and a ratio of said first distance to said third distance being between 0.80 and 0.95.

10. The integrated drive generator as set forth in claim 9, wherein a fourth distance defined between an end of said disc facing said first end and said second end and a ratio of said second distance to said fourth distance being between 0.050 and 0.075.

11. The integrated drive generator as set forth in claim 10, wherein there are one hundred of said gear teeth and twenty-two spline teeth.

12. The integrated drive generator as set forth in claim 9, wherein there are one hundred of said gear teeth and twenty-two spline teeth.

13. The integrated drive generator as set forth in claim 8, wherein there are one hundred of said gear teeth and twenty-two spline teeth.

14. The integrated drive generator as set forth in claim 8, wherein there are two of said hydraulic units.

15. A method of replacing a fixed block shaft in an integrated drive generator comprising the steps of:
a) removing an existing fixed block shaft from an integrated drive generator having an input shaft connected to a differential, said differential connected to a generator, and said differential also being connected to a hydraulic unit, said hydraulic unit including a variable swash plate and a fixed swash plate, and each of said swash plates being associated with a set of pistons, and a fixed shaft associated with said fixed shaft plate, and driven to rotate by a cylinder block associated with said fixed swash plate, and said fixed shaft including a spline connection to drive the existing fixed block shaft, said existing fixed block shaft having gear teeth engaged to a ring gear in said differential; and
b) and replacing the existing fixed block shaft with a replacement fixed block shaft having a body extending from a first end to a second end and a disc extending radially outwardly of a shaft portion, said shaft portion extending to said second end and said disc extending radially outwardly from said shaft adjacent said first end with a boss extending to said first end from said disc, said boss defining an inner peripheral surface, and said inner peripheral surface being a bearing race, and said bearing race extending from said first end to a bearing race end, and an inner diameter of said bearing race defining a first distance, an inner diameter of said bearing race being defined as a first distance and said bearing race extending along a central axis for a second distance, and a ratio of said first distance to said second distance being between 4.30 and 4.50.

16. The method of replacing a fixed block shaft as set forth in claim 15, wherein an outer diameter of said boss is defined as a third distance, and a ratio of said first distance to said third distance being between 0.80 and 0.95.

17. The method of replacing a fixed block shaft as set forth in claim 16, wherein a fourth distance defined between an end of said disc facing said first end and said second end and a ratio of said second distance to said fourth distance being between 0.050 and 0.075.

18. The method as set forth in claim 17, wherein there are one hundred of said gear teeth and twenty-two spline teeth.

19. The method as set forth in claim 16, wherein there are one hundred of said gear teeth and twenty-two spline teeth.

20. The method as set forth in claim 15, wherein there are one hundred of said gear teeth and twenty-two spline teeth.
